(19) United States
(12) Patent Application Publication
(10) Pub. No.: US 2022/0339708 A1
(43) Pub. Date: Oct. 27, 2022

(54) BUILD ORIENTATION OPTIMISATION METHOD AND SYSTEM FOR PRODUCING AN ARTICLE BY ADDITIVE MANUFACTURING

(71) Applicant: LPW TECHNOLOGY LTD, Widnes, Cheshire (GB)

(72) Inventor: Nicholas Paul WEEKS, Over Peover, Cheshire (GB)

(73) Assignee: LPW TECHNOLOGY LTD, Widnes, Cheshire (GB)

(21) Appl. No.: 17/787,211

(22) PCT Filed: Dec. 8, 2020
(86) PCT No.: PCT/GB2020/053144

§ 371 Date: Jun. 17, 2022

(30) Foreign Application Priority Data
Dec. 17, 2019 (GB) 1918650.1

(51) Int. Cl. B22F 10/80; B33Y 30/00; B33Y 50/00; B22F 12/58; B22F 10/73; B22F 10/37; B33Y 40/10

(52) U.S. Cl. CPC B22F 10/80; B33Y 30/00; B33Y 50/00; B22F 12/58; B22F 10/73; B22F 10/37; B33Y 40/10

(57) ABSTRACT

The present application relates to a method of producing an article by additive manufacturing including the steps of predicting regions of stress in the article, identifying an optimal build orientation for the article and dispensing a first powder and/or a second powder to form the article. The first and second powders are of the same type of powder and have been recycled to different extents and the orientation of the build is optimised so that reduced quantities of the powder which has not been recycled or which has been recycled to a lesser extent is dispensed during the build.

### TECHNICAL FIELD OF THE INVENTION

The present invention relates to a method and system for producing an article by additive manufacturing.

### BACKGROUND TO THE INVENTION

Metal powder based Additive Manufacturing (AM) is gaining popularity in the aerospace, medical, electronics and automobile industry, as complex components can be built with relative ease.

In a typical AM process a CAD model of the article to be produced is first generated. The model may then be refined in order to improve the quality and accuracy of the final article being built. The model (or data derived therefrom) is then processed to form instructions which control the AM machine. The AM machine then deposits a layer of powder on a build platform based on the instructions it receives and the powder is subsequently selectively fused or otherwise solidified, typically with a laser or electron beam, to form an article or articles. The process is repeated so that articles are formed layer by layer.

During a build operation unfused powder is subject to degradation. A metal powder may gradually oxidise, for example, which alters its properties and thus those of an article produced from the powder. The tendency of a powder to oxidise typically increases with temperature, and exposure to temperature may also affect other powder properties. It is typical within the industry to re-use or “recycle” the unfused powder in another build, despite it containing degraded particles. While this is a common approach to reducing costs without significantly compromising the quality and integrity of the article, there remains a risk that the presence of degraded particles in regions where the article will be subjected to stress in use, could lead to premature failure of the article in that region.

In light of the above it is an object of embodiments of the present invention to provide a more economic route for producing an article through additive manufacturing. In particular, it is an object of embodiments of the present invention to provide a method which minimises the use of powder which does not contain degraded particles or which contains a low concentration of degraded particles without compromising the integrity or quality of the article. It is a further object of embodiments of the present invention to provide a user with improved control over how powder which does not contain degraded particles or which contains a low concentration of degraded particles is utilised in a build operation.

### SUMMARY OF THE INVENTION

According to a first aspect of the invention there is provided a method of producing an article by additive manufacturing comprising the steps of predicting regions of stress in the article, identifying an optimal build orientation for the article and dispensing a first powder and/or a second powder to form the article, wherein the first and second powders are of the same type of powder and have been recycled to different extents, and wherein the orientation of the build is optimised to reduce the quantity of the powder in the build which has either not been recycled or which has been recycled to a lesser extent.

The method according to the first aspect of the invention enables articles to be produced at reduced cost without compromising the quality or integrity of the build. In particular, it has been found that optimising the build orientation ensures that the powder which has either not been recycled or which has been recycled to a lesser extent, and which is of higher value, is either not dispensed or dispensed in reduced quantities in regions of the article where it is not strictly needed, i.e. in regions which are not predicted to experience higher levels of stress in use. Instead, in these ‘low stress’ regions, the powder which has been recycled to a greater extent can be deposited exclusively or deposited as part of a blend in higher quantities. Thus, the more efficient utilisation of the higher value powder results in a more economic manufacturing route to producing an article or articles by additive manufacturing.

The method may comprise the step of performing a stress analysis on a model of the article to predict regions of stress in the article. In some embodiments the stress analysis may comprise the step of slicing the model to produce two-dimensional cross-sections and performing a stress analysis on the two-dimensional cross-sections. In this way, numerical stress values for each two-dimensional cross-section can be obtained which in turn leads to a more accurate prediction of stress in a given region and for a given layer of the build. The stress analysis may comprise finite element analysis.

The method may comprise the step of rotating the model until an optimised build orientation for the article is obtained. For example, the model may be rotated from a substantially vertical orientation to a substantially horizontal orientation, e.g. through 90°.

Support structures are typically employed to provide mechanical support to overhangs and thin walls in the article being produced. In some embodiments the orientation of the build may be optimised to minimise support structure volume since this allows the cost of the build to be further reduced. For example, the method may comprise the step of orienting the build so that it is substantially self-supporting. In particular, the method may comprise the step of orienting the build at an angle between 45° and 90° relative to the build platform.

The first powder may comprise a non-recycled powder and the second powder may comprise powder that has been recycled one or more times. In the context of the present invention non-recycled powder is “virgin” powder that has not previously been subjected to the conditions of a build operation, whereas “recycled” powder may be defined as powder that has been exposed to one or more AM build cycles and is re-used in one or more further AM build cycles. Given that virgin powder does not contain degraded particles, it is considered to be of higher value compared to recycled powder.

In some embodiments the first powder and the second powder may comprise recycled powders. For instance, the first powder may have been previously subjected to the conditions of a single build operation while the second powder may have been subjected to two or more build operations.

Mixing of the first powder and the second powder may occur once the powders have been dispensed onto a build platform. Alternatively, mixing of the first powder and the second powder may occur prior to dispensing the powders onto the build platform.

In some embodiments the first powder and the second powder may comprises a metal or a metal alloy. For example, the powder may comprise titanium metal or a titanium alloy such as Ti-6Al-4V.

The ratio of the first powder to the second powder may be varied in dependence on predicted stress in a region of the article. In some embodiments the ratio of the first powder to the second powder is varied in dependence on the predicted stress in that region and on either a predicted or analysed condition of the recycled metal powder.

In some embodiments the ratio of the first powder to the second powder in one layer may be the same or different to the ratio of the first powder to the second powder in a previous layer.

According to a second aspect of the invention there is provided a system comprising a processor for controlling the operation of an additive manufacturing machine to produce an article, wherein the additive manufacturing machine comprises a first container and a second container from which powder may be selectively dispensed to form the article, wherein the first container and the second container contain the same type of powder and respectively contain powder that has been recycled to different extents and wherein the processor is configured to determine an optimised build orientation for reducing the quantity of the powder which has not been recycled or which has been recycled to a lesser extent that is dispensed to produce the article.

The processor may be communicatively coupled to the additive manufacturing machine. The processor may be configured to receive or generate a model of the article. The model may be a 3D model of the article. In particular, the 3D model may be generated using computer aided design (CAD) software.

The processor may be configured to perform a stress analysis on the model to predict regions of stress in the article and to determine the optimised build orientation based on results of the stress analysis. In particular, the stress analysis performed by the processor may comprise finite element analysis (FEA).

The processor may be configured to determine a build orientation that additionally minimises support structure volume.

### DETAILED DESCRIPTION OF THE INVENTION

In order that the invention may be more clearly understood one or more embodiments thereof will now be described, by way of example only, with reference to the accompanying drawings, of which:

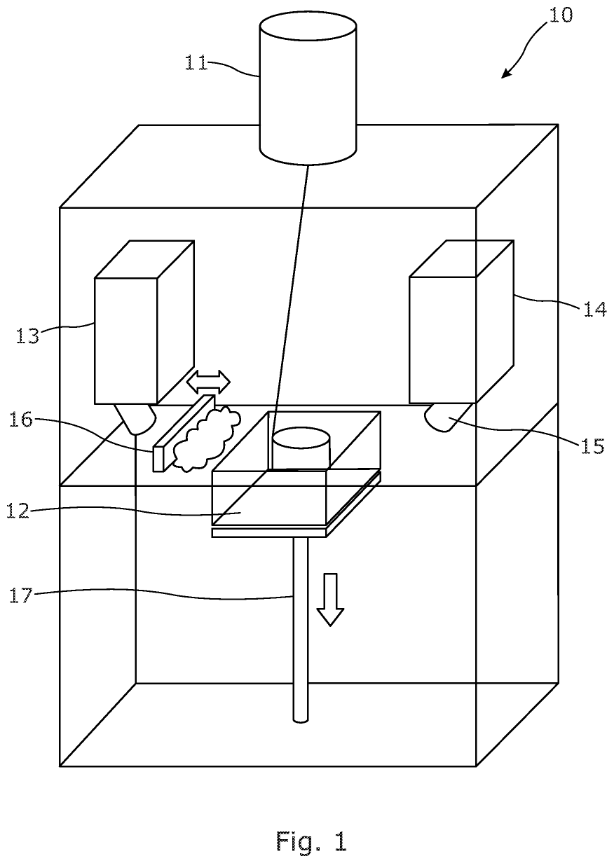

FIG. 1 shows an example of an apparatus for additively manufacturing an article.

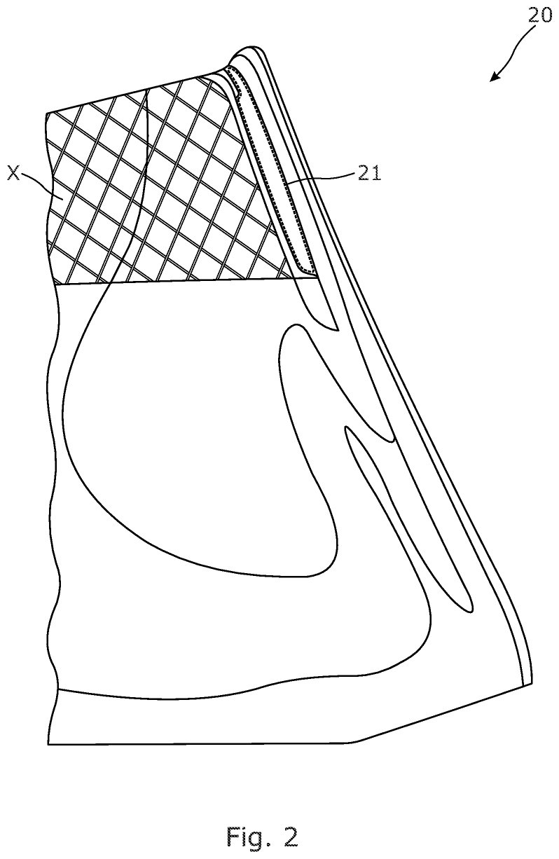

FIG. 2 shows a schematic of a model of an article in a first non-optimised build orientation.

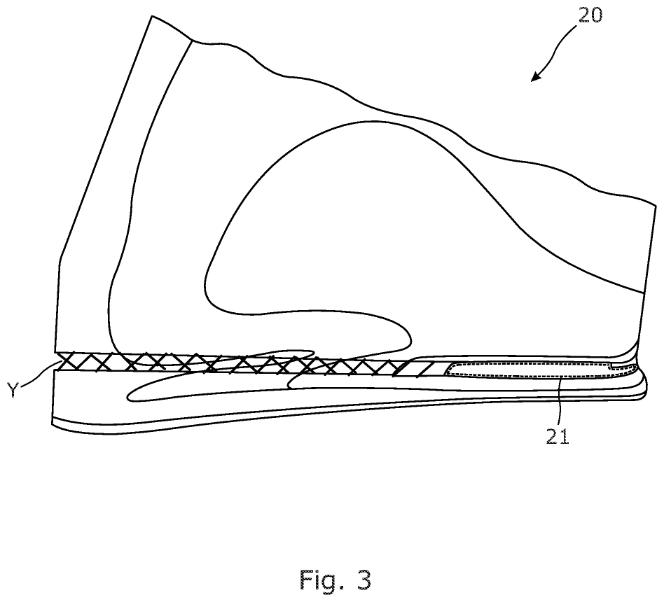

FIG. 3 shows a schematic of a model of an article in a second optimised build orientation.

Referring to FIG. 1 and in one exemplary embodiment of the invention there is provided an apparatus 10 for producing an article by additive manufacturing. The apparatus 10 comprises a laser beam 11 for irradiating selected regions of powder on a build platform 12, a first container 13 for containing a first powder, a second container 14 for containing a second powder, electronic valves 15 for controlling the flow of powder from the first and second containers 13, 14, a wiper 16 which is operable to form a layer of powder on the build platform 12 and a building screw 17 for lowering the build platform 12 during the build. In this example the first container 13 and the second container 14 both contain titanium powder. More specifically, the first container 13 contains titanium powder that has not been recycled (powder A), whereas the second container 14 contains titanium powder that has been recycled at least once (powder B), i.e. the first and second containers 13, 14 contain the same type of powder, the only difference being the extent to which the respective powders have been recycled.

FIG. 2 is a representation of a CAD model 20 of an article to be produced by additive manufacturing in a first build orientation. The CAD model 20 may be generated on or received by a personal computer or similar device external to the additive manufacturing machine 10. Prior to commencing the build operation the CAD model 20 is subjected to finite element analysis (FEA) which is a computerised method for predicting how a product reacts under various physical conditions such as stress. The CAD model 20 may be refined and subjected to a further FEA if needed. Accordingly, FEA enables a user to predict regions of strain and stress in the article and possible regions where the article could fail during use.

As shown in FIG. 2 the CAD model 20 of the article has a region of high stress designated by reference numeral 21. Accordingly, it is desirable to deposit layers containing increased quantities of powder A in that region in order to minimise the accumulation of degraded particles in the region 21 where the article is most likely to fail in use. On the other hand, in regions of the article which experience less stress, it is preferable to deposit layers that contain higher proportions powder B which is less valuable due it containing a higher content of degraded particles.

FIG. 2 also shows the CAD model 20 of the article in a non-optimised build orientation since in this orientation the article would be more costly to build. This is because in addition to the region 21 of high stress, increased quantities of powder A will be deposited in the remainder of the layers (see hatched area X). FIG. 3 on the other hand shows a CAD model 20 of the same article in an optimised build orientation in which the article (and region of high stress) has been rotated from a substantially vertical orientation to a substantially horizontal orientation having the effect of reducing the quantity of powder A that will be deposited outside of the region of high stress (see hatched area Y). Since reduced quantities of the more expensive/more valuable powder A will be deposited in the orientation shown in FIG. 3, the overall cost of additively manufacturing the article is reduced.

Once an optimised build orientation has been determined which minimises the unnecessary use of powder A in regions of the article where it is not required or required to a lesser extent, the CAD model 20 is sliced electronically to obtain a series of 2D layers, which each define a planer cross section through the model 20 of the article. Numerical stress values obtained from the FEA analysis are then reviewed and analysed for each of the layers in order to identify the highest numerical stress value, i.e. the worst case scenario, for each layer. Using this information, reference data relating to the degradation behavior of titanium powder and the application requirements of the article being produced, a user or an algorithm is able to determine an appropriate mix ratio of powder A and powder B for each layer. The mix ratio for each layer is stored on the personal computer or similar device. A processor then converts the 3D model in its optimised orientation and an optimised mix ratio of powder A and powder B for a given layer into a set of instructions which can be understood by the additive manufacturing machine 10.

The personal computer (or similar device) is communicatively coupled to the AM machine 10 so that the processor can output the instructions to the AM machine 10 to produce the article in the optimised orientation as depicted in FIG. 3. Upon receiving the instructions from the processor, one or both electronic valves 15 are opened so that pre-determined quantities of powder A and powder B are dispensed from the first and second containers 13, 14 onto the build platform 12. In another example of the invention powder A and powder B are dispensed into a third container (not shown) to promote mixing of the respective powders before they are dispensed onto the build platform 12.

As discussed above, the ratio of powder A to powder B may be varied in dependence on the predicted stress in a region of the article, also taking into account the degradation behavior of powder B. This means that layers of the article which do not experience high levels of stress, e.g. layers above and below region 21 (FIG. 3), will contain higher proportions of powder B, whereas layers which are predicted to experience higher levels of stress such as those in region 21, will contain higher proportions of powder A. It will be appreciated that in certain instances the powder may contain 100% of powder A or 100% of powder B depending on the predicted stress in a particular region and the application requirements of the article being built.

To ensure that the layer of blended powder has a substantially uniform thickness, the wiper 16 is brought into engagement with the powder and is then moved back and forth so that powder is spread across the build platform 12 until the desired layer thickness is obtained. The wiper 16 is then retracted and held out of contact with the powder. In forming the layer of blended powder it will be appreciated that a proportion of the blended powder will be wiped from the surface of the build platform 12. This powder is collected in collection chambers located either side of the build platform 12 so that this unfused powder can be re-used.

Selected regions of powder corresponding with the desired shape of the article in its optimised build orientation are then irradiated with the laser beam 11 which causes powder in the layer to fuse and form a solid mass on cooling. Powder is then dispensed from the first container 13 and/or the second container 14 on to the build platform 12 and the above described process of forming a layer with uniform layer thickness and irradiating selected regions with a laser beam 11 is repeated until the article is formed. It will be appreciated that the ratio of powder A to powder B in each subsequent layer may be the same or different to the previous layer and that the ratio will depend on the predicted stress in that particular region of the article as determined by the FEA analysis.

The one or more embodiments are described above by way of example only. Many variations are possible without departing from the scope of protection afforded by the appended claims.

1. A method of producing an article by additive manufacturing comprising the steps of:
predicting regions of stress in the article;
identifying an optimal build orientation for the article, and
dispensing a first powder and/or a second powder to form the article, wherein the first and second powders are of the same type of powder and have been recycled to different extents, and wherein the orientation of the build is optimised so that reduced quantities of the powder which has not been recycled or which has been recycled to a lesser extent is dispensed during the build.

2. A method according to claim 1, wherein the method comprises the step of performing a stress analysis on a model of the article to predict regions of stress in the article in use.

3. A method according to claim 2, wherein the method comprises the step of slicing the model to produce two-dimensional cross-sections and subjecting the two-dimensional cross-sections to the stress analysis.

4. A method according to claim 1, wherein the method comprises the step of rotating the model until an optimised build orientation for the article is obtained.

5. A method according to claim 1, wherein the orientation of the build is further optimised to minimise support structure volume.

6. A method according to claim 5, wherein the build is oriented to be substantially self-supporting.

7. A method according to claim 6, wherein the build is oriented at an angle between 45° and 90° relative to the build platform.

8. A method according to claim 1, wherein the first powder comprises non-recycled powder and the second powder comprises powder that has been recycled one or more times.

9. A method according to claim 1, wherein the first powder and the second powder comprise recycled powders.

10. A method according to claim 1, wherein mixing of the first powder and the second powder occurs once the powders have been dispensed onto a build platform.

11. A method according to claim 1, wherein mixing of the first metal powder and the second metal powder occurs prior to dispensing the metal powders onto the build platform.

12. A method according to claim 1, wherein the ratio of the first powder to the second powder is varied in dependence on predicted stress in a region of the article.

13. A method according to claim 12, wherein the ratio of the first powder to the second powder is varied in dependence on the predicted stress in that region and on either a predicted or analysed condition of the recycled metal powder.

14. A method according to claim 12, wherein the ratio of the first metal powder to the second powder in one layer is the same or different to the ratio of the first metal powder to the second metal powder in a previous layer.

15. A system comprising a processor configured to operate an additive manufacturing machine to produce an article, wherein the additive manufacturing machine comprises a first container and a second container from which powder may be selectively dispensed to form the article, wherein the first container and the second container contain the same type of powder and respectively contain powder that has been recycled to different extents and wherein the processor is configured to determine an optimised build orientation for reducing the quantity of the powder which has not been recycled or which has been recycled to a lesser extent that is dispensed to produce the article.

16. A system according to claim 15, wherein the processor is communicatively coupled to the additive manufacturing machine.

17. A system according to claim 15, wherein the processor is configured to receive or generate a model of the article.

18. A system according to claim 15, wherein the processor is configured to perform a stress analysis on the model to predict regions of stress in the article and to determine the optimised build orientation based on results of the stress analysis.

19. A system according to claim 18, wherein the stress analysis performed by the processor comprises finite element analysis.

20. A system according to claim 15, wherein the processor is configured to determine a build orientation that minimises support structure volume.
